(19) United States
(12) Patent Application Publication
(10) Pub. No.: US 2010/0161670 A1
(43) Pub. Date: Jun. 24, 2010

(54) Method of Visual Addressing Commands in a Tree Structure

(76) Inventor: Alexander Yurov, Moskovskaya obl. (RU)

Correspondence Address: Aleksandr Smushkovich, POB 140505, Brooklyn, NY, 11214, US

(21) Appl. No.: 11/989,247

(22) PCT Filed: Jul. 27, 2006
(86) PCT No.: PCT/RU2006/000401

§ 371 Date: Aug. 3, 2009

(30) Foreign Application Priority Data
Jul. 28, 2005 (RU) 2005124030

(51) Int. Cl. G06F 17/30

(52) U.S. Cl. 707/797; 707/E17.012

(57) ABSTRACT

The invention is related to the field of computer science and can be used while entering and editing data. The technical result of the invention is speeding up the way the user works with data presented in the tree form. This result is obtained thanks to the possibility to move the caret within the tree structure display area and to treat commands entered by the user depending on the position of the caret.

Class G 06 F 3/00. The invention is related to the field of computer science and can be used while entering and editing data.

Structuring of data in the form of a tree is widely used in computer science; to display such data, a special component, also called a tree, is used, which displays nodes and subnodes, visualizing relations between them as lines, as well as textual information corresponding to the nodes. Thus, the entire display area can be divided into two parts: the area, which displays textual information and the area, which displays the tree structure. To perform operations on tree nodes, the following is used: selecting them using the mouse, entering commands by the user and processing of these commands. To edit text corresponding to the selected node, a visual element called a caret is displayed, which shows the place for text input. The user can move the caret only in the text display area. This is, for example, the way the TreeView component by Borland works. Its description is available in the “C++ Builder 6 Programming” book by A. Y. Archangelsky, M.:ZAO “BINOM Publishing House” 2003.

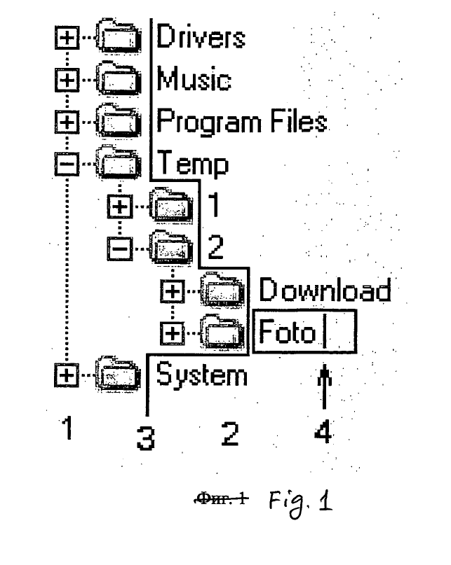

The FIG. 1 shows a part of a computer filesystem displayed as a tree with the following notation: 1 is the part where the tree structure is displayed, 2 is the part where the textual information is displayed, 3 is the line showing the border between these areas, 4 is the caret.

The disadvantage of the method of selecting nodes using the mouse is that it requires a lot of time to find the necessary node especially if the tree in question is large.

The technical result of the invention is speeding up the way the user works with data presented in the tree form.

This achievement becomes possible by giving the user the possibility to quickly specify the necessary position in the displayed tree structure.

To solve this problem, a visual method is suggested, which includes the following operations: processing of commands entered by the user, permission to move the caret from the text input area to the tree structure area, processing of subsequent commands according to the relative position of the caret in the tree structure being displayed.

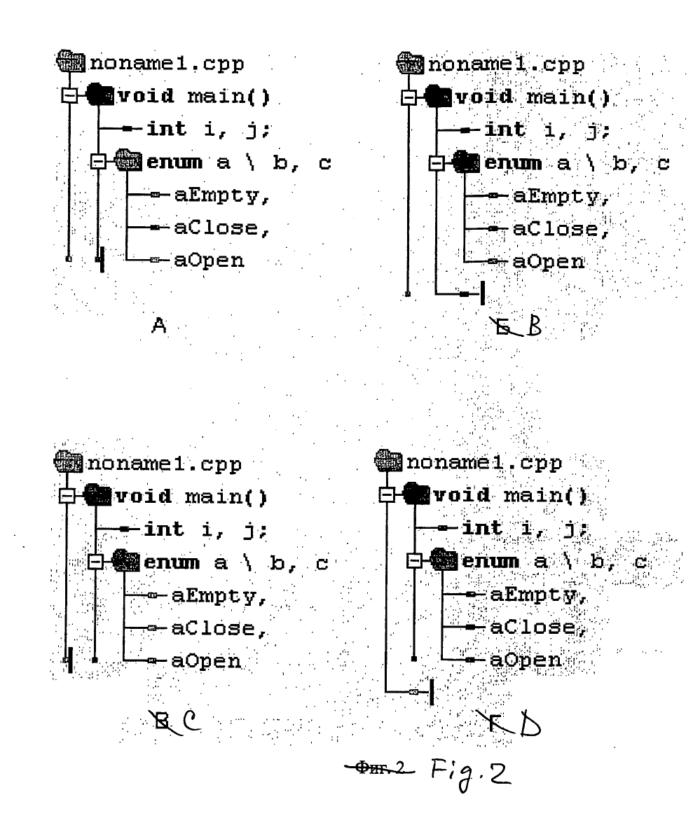

FIG. 2 shows that using this method, the user can quickly add a node to the tree on the necessary level, which is selected depending on the exact position where the user moved the caret from the text display area to the tree display area. FIGS. 2a and 2b display the initial position of the caret before receiving the node insertion command and the place in the tree where the node will be added to. FIGS. 2c and 2d show how the same operation is performed if the node needs to be inserted one level higher. As the figure shows, the processing result of the command depends on the position of the caret.

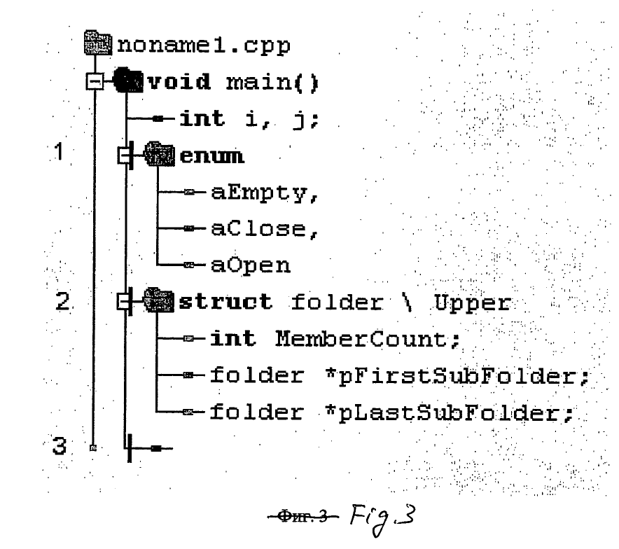

FIG. 3 shows three consecutive positions of the caret when it receives three Move Down commands. This shows how the user can specify the necessary level by moving the caret in the corresponding position in the tree structure, and quickly navigate the tree.

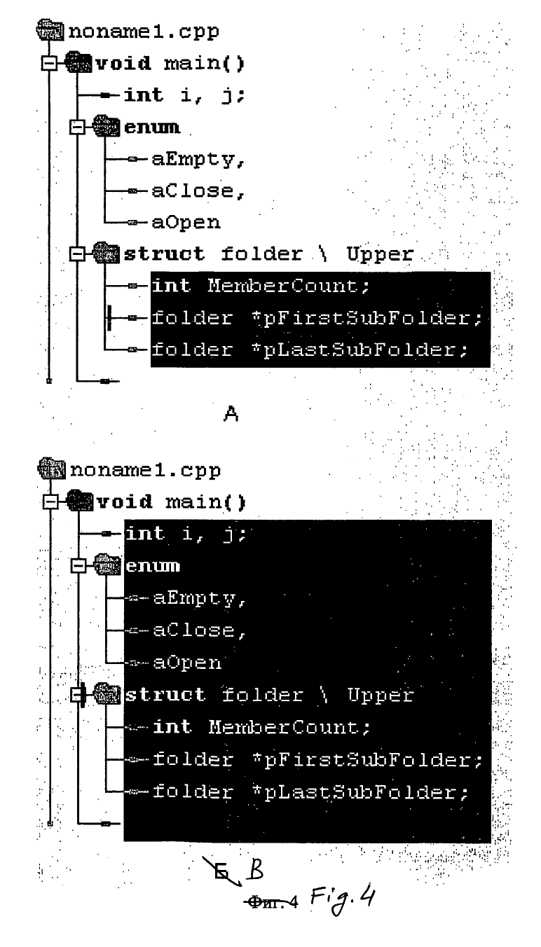

FIGS. 4a and 4b show how the user can move the caret into a specific position and select all nodes in the corresponding level by using the Select All command.

Specific operations and the way they are related to the caret position can vary and depend on the type of data being displayed and rules of processing of this data. The best case is having those operations performed in the tree and the commands to move in the tree, which are similar to the operations and commands in the text area, activated by the same key presses and correspond to the generally accepted key designations. For example, pressing the “Enter” key usually adds a new line to the text. A similar tree operation is adding a new node, which is shown at FIG. 2. This operation can also be performed by pressing the “Enter” key.

It is also possible to replace the caret by another visual element, whose position can be controlled using the keyboard, and display it in the tree instead of the caret. In this case the caret may be visible or hidden.

1. A method of visual addressing of commands in the tree, which consists of the following: the caret is allowed to move to the tree structure display area, and commands entered by the user are processed depending on the position of the caret in the tree structure display area.

2. A method according to claim 1, which differs in that another visual element, instead of the caret, is used for addressing.
